(19) United States
(12) Patent Application Publication
(10) Pub. No.: US 2012/0202427 A1
(43) Pub. Date: Aug. 9, 2012

(54) DOCKING STATION FOR PORTABLE COMPUTING DEVICES

(76) Inventors: Richard GIOSCIA, Santa Clara, CA (US); Seungheon Lee, Milpitas, CA (US); Philip Bryan, San Francisco, CA (US); Manjirnath Chatterjee, San Francisco, CA (US); William Justin Grange, San Francisco, CA (US); Jijian Zhang, Sammamish, WA (US); Edward Chejlava, San Bruno, CA (US)

(21) Appl. No.: 13/170,847

(22) Filed: Jun. 28, 2011

Related U.S. Application Data
(60) Provisional application No. 61/440,656, filed on Feb. 8, 2011.

(51) Int. Cl. H04B 7/00; G06F 1/16

(52) U.S. Cl. 455/41.2; 361/679.41

(57) ABSTRACT

A docking station that includes a base and a retention structure. The base is structured to rest on an underlying surface. The retention platform includes a receiving surface that is elevated from and supported by the base. A magnetic coupling mechanism is provided on the retention platform in order to magnetically retain a computing device that is rested on the receiving surface.

### RELATED APPLICATIONS

This application claims the benefit of priority under 35 U.S.C. 119(e) to Provisional Application Ser. No. 61/440,656, filed Feb. 8, 2011, titled “Docking Station for Portable Computing Devices”, which is incorporated herein by reference in its entirety.

### TECHNICAL FIELD

Embodiments described herein pertain generally to a docking station for portable computing devices.

### BACKGROUND

The use of docking stations and other accessory devices in connection with mobile computing devices (e.g. smart phones, media players etc.) is well known. Traditionally, docking stations are used to (i) recharge or supply power to the mobile computing device, (ii) enable the computing device to communicate with other devices connected to the docking station (e.g., synchronization with a personal computer), or (iii) use additional resources provided with the docking station (e.g., speakers for audio output).

In a traditional scheme, docking stations and mobile computing devices connect using insertive male/female connectors. Numerous factors come into consideration when mobile devices are designed with connectors for use with docking stations. For example, such connectors typically take into account the ease by which users may establish the connection (e.g., the user can simply drop the device into the cradle), as well as the mechanical reliability of the connectors. When users repeatedly mate devices with docking stations, both the mating action and the removal of the device from the docking station can strain the connector structure and its elements.

Connectors also restrain the amount by which a device's form factor can be reduced in thickness and/or other dimensions. Connector schemes (particularly those that abide by an industry standard) have constraints that dictate the physical dimensions of the male and female ends of the connectors. As devices get smaller, accommodating the size constraints of the connectors has become more challenging.

### BRIEF DESCRIPTION OF THE DRAWINGS

FIG. 1A is a side view of a docking station that includes an elevated retention platform, according to an embodiment.

FIG. 1B is a front view of the docking station of FIG. 1A.

FIG. 2A is an isometric view of a docking station that includes a mufti-device receiving surface, according to one or more embodiments.

FIG. 2B illustrates the docking station of FIG. 2A, receiving a tablet type, according to an embodiment.

FIG. 2C illustrates the docking station of FIG. 2A, receiving a small-form factor or mobile device, according to an embodiment.

FIG. 3A is a front view of the docking station of FIG. 2A.

FIG. 3B is a side view of the docking station of FIG. 3A.

FIG. 3C is a rear isometric view of the docking station of FIG. 3A.

FIG. 3D is a rear view of the docking station of FIG. 2A.

FIG. 4 illustrates a hardware diagram for a docking station, in accordance with embodiments described herein.

### DETAILED DESCRIPTION

Embodiments described herein provide a enhanced docking station for a computing device that provides an elevated retention surface for receiving a mated computing device.

More specifically, embodiments described herein include a docking station that includes a base and a retention platform or structure. The base is structured to rest on an underlying surface. The retention platform includes a receiving surface that is elevated from, and supported by the base. A magnetic coupling mechanism is provided with the retention platform in order to magnetically retain a computing device that is positioned on the receiving surface. A computing device may be retained at an acute angle relative to the base.

According to some embodiments, the retention platform is structured to retain multiple types of computing devices. In particular, some embodiments provide that the receiving surface is contoured in a manner that enables retention to devices of different form factors or dimensions. Still further, in some embodiments, the receiving surface is contoured or otherwise structured to receive designated (e.g., rear) façades of various other devices.

Additionally, one or more embodiments provide that the docking station includes an inductive signal interface for purpose of inductively coupling to a computing device. The inductive signal interface may signal power and/or data to the computing device.

In some embodiments, the docking station may include resources for pairing to the computing device wirelessly using inductively signaled data (e.g., inductive or near-field communication). As an alternative or addition, the docking station may also wirelessly pair the computing device to another device that is connected to the computing device.

As used herein, the term “inductive” or “inductively” refers to use of electromagnetism to transfer an electrical signal. An inductive signal transfer uses electromagnetic flux variations or electromagnetic resonance to induce signal transfer. Electromagnetic resonance or evanescent coupling can enable inductive coupling even when the devices that are being coupled are physically separated from one another. An inductive signal interface refers to components (logic and hardware) for enabling inductive signal transfer.

Some embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Some embodiments described herein may generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances or laptop computers. Thus, memory, processing and network resources may all be used in connection with the establishment, use or performance of any embodiment described herein (including with the performance of any method or with the implementation of any system).

Furthermore, some embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs), and magnetic memory. Computers, terminals, network enabled devices (e.g. mobile devices such as cell phones) are all examples of machines and devices that utilize processors, memory, and instructions stored on computer-readable mediums.

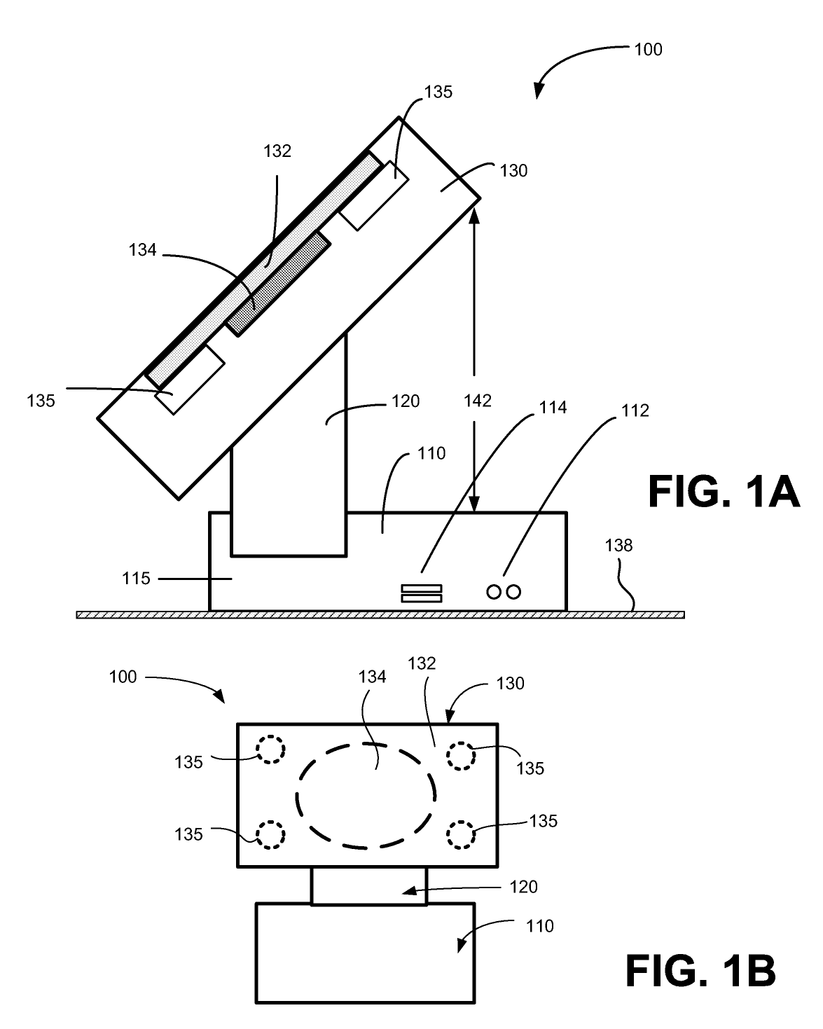

FIG. 1A and FIG. 1B illustrate a docking station having an elevated retention structure for receiving computing devices, according to one or more embodiments. FIG. 1A is a side view of docking station 100, including a base structure 110, an extension member 120 that extends vertically from the base structure, and a retention platform 130 on which a computing device (not shown) may be received and retained. The base structure 110 may rest on an underlying surface 138 (e.g., a table top), and support a computing device that is received on the retention platform 130.

The extension member 120 may extend at an angle from the base 110. In some embodiments, the extension member 120 extends from a front end 115 of the base structure 110. The retention platform 130 is provided acutely on the extension member 120, so that a void 142 or opening is formed by the retention platform 130 overhanging the base structure 110.

The retention structure 130 includes a receiving surface 132 that is shaped or otherwise structured to receive multiple types of devices. In order to operatively retain a computing device, the receiving surface 132 may be provided with magnets 135 that surround or otherwise affect a magnetic field about the receiving surface 132 in order to retain other computing devices. In one implementation, magnets 135 may correspond to, for example, rare-earth magnets. In variations, electronic resources may be provided with the receiving surface 132 in order to affect an electro-magnet. The retention structure 130 may also be provided with an inductive signal interface 134 that can communicate (send or receive) power and/or data with mated computing devices that include compatible inductive signal interfaces. In one embodiment, the inductive signal interface 134 is designed to requirements that enable it to signal power, as well as to exchange data over an inductive medium with a compatible computing device that is rested on the receiving surface 132. The inductive signal interface 134 may include one or more coils (not shown) that signal power and/or data (which can be signaled through, for example, signal modulation). The following patent applications, which are each incorporated by reference in their respective entirety, describe the use of inductive signal interfaces as between computing devices and docking stations, including the automatic establishment of wireless links and extended functionality using inductively communication data: U.S. patent application Ser. No. 12/916,388, filed Oct. 29, 2010; U.S. patent application Ser. No. 12/620,478, filed Nov. 17, 2009; and U.S. patent application Ser. No. 12/478,766, filed Jun. 4, 2009.

In order to electrically power the inductive signal interface 134 and operate internal electrical resources, the docking station 100 may include a power inlet and/or battery (which can be rechargeable). The base structure 110 may include power input ports 112, physical connector ports 114 (e.g., USB connectors, Firewire connectors), and/or plug connectors (e.g., RCA jacks) for transferring media data. In some embodiments, the docking station 100 includes one or more wireless ports to form wireless links with computing devices. For example, the docking station may include resources for forming wireless connections such as those formed under Bluetooth, Wi-Fi (or 802.11(b), (g), (n)) Wi-Max, or cellular connections. The docking station 100 may also include one or more network ports for forming connections to local area networks or the Internet.

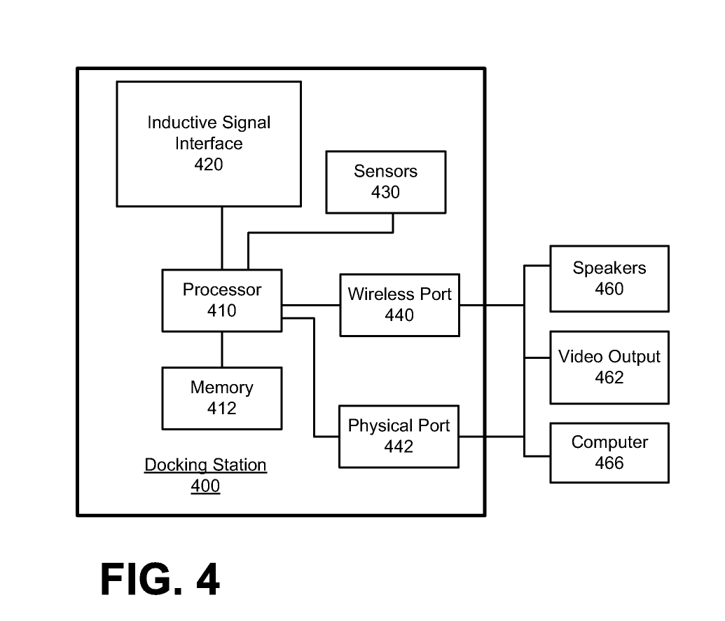

As described with an embodiment of FIG. 4, the electronic resources of the docking station 100 may also include one or more processors, memory, antennas and/or radios for effecting wireless radio frequency (RF) connections (e.g., Bluetooth, cellular). The resources may be distributed between the base 110 and the retention structure 130. Wiring such as a flex cable may be used to interconnect resources (e.g., inductive signal interface) retained in the retention structure 130 to resources retained by the base structure 110.

As an addition or variation to embodiments described which incorporate inductive signal interface, a near field communication interface may be provided with the receiving surface 132 to exchange data with a mated computing device. As still additional variations, some embodiments may provide for the retention structure to include a physical electrical connector for receiving a computing device.

FIG. 1B is a frontal view of the docking station of FIG. 1A, according to an embodiment. The base structure 110 supports extension member 120 in an upright or partially upright position. The retention structure 130 includes receiving surface 132 that is acutely angled with the horizontal surface. The receiving surface 132 may be provided as a façade of the retention structure 130. The inductive signal interface 134 and magnets 135 may be embedded within the retention structure. For example, the receiving surface 132 may be implemented as a plastic or glass surface that overlays the coils of the inductive signal interface 134 and magnets 135.

With reference to FIG. 1A and FIG. 1B, the docking station 100 may be formed from various types of materials and manufacturing techniques. The docking station 100 may be provided as a single-piece (i.e., unitary construction or mufti-piece component). In particular, the docking station 100 may be formed from metal, such as aluminum. In other variations, the docking station 100 is formed from plastic. An extrusion process, such as a floating core extrusion, may be used to manufacture the docking station 100 to include the various structural features described.

Various functionality may be provided by docking station 100. In particular, docking station 100 may supply power, exchange data and information, and/or enabled a mated device to connect to resources or connected devices of the docking station. For example, the docking station 100 may interconnect to speakers, monitors, or other computing devices. Additionally, the docking station may include resources to interconnect the mated computing device to its resources or attached/connected devices. In some embodiments, the docking station 100 includes logic and resources to automatically pair with the mated computing device over a local wireless communication medium, such as provided by Bluetooth or Wi-Fi (e.g., 802.11 (g) or (n)). Still further, the docking station 100 may use this inductive signal interface 134 (or alternatively, an NFC interface) to receive or exchange credential information for establishing such wireless links. The following patent applications, which are hereby incorporated by reference in their respective entirety, describe the programmatic and/or substantially automated formation of wireless links between docking station and computing device, using inductively exchanged credential information: U.S. patent application Ser. No. 12/916,388, filed Oct. 29, 2010; U.S. patent application Ser. No. 12/620,478, filed Nov. 17, 2009; and U.S. patent application Ser. No. 12/478,766, filed Jun. 4, 2009.

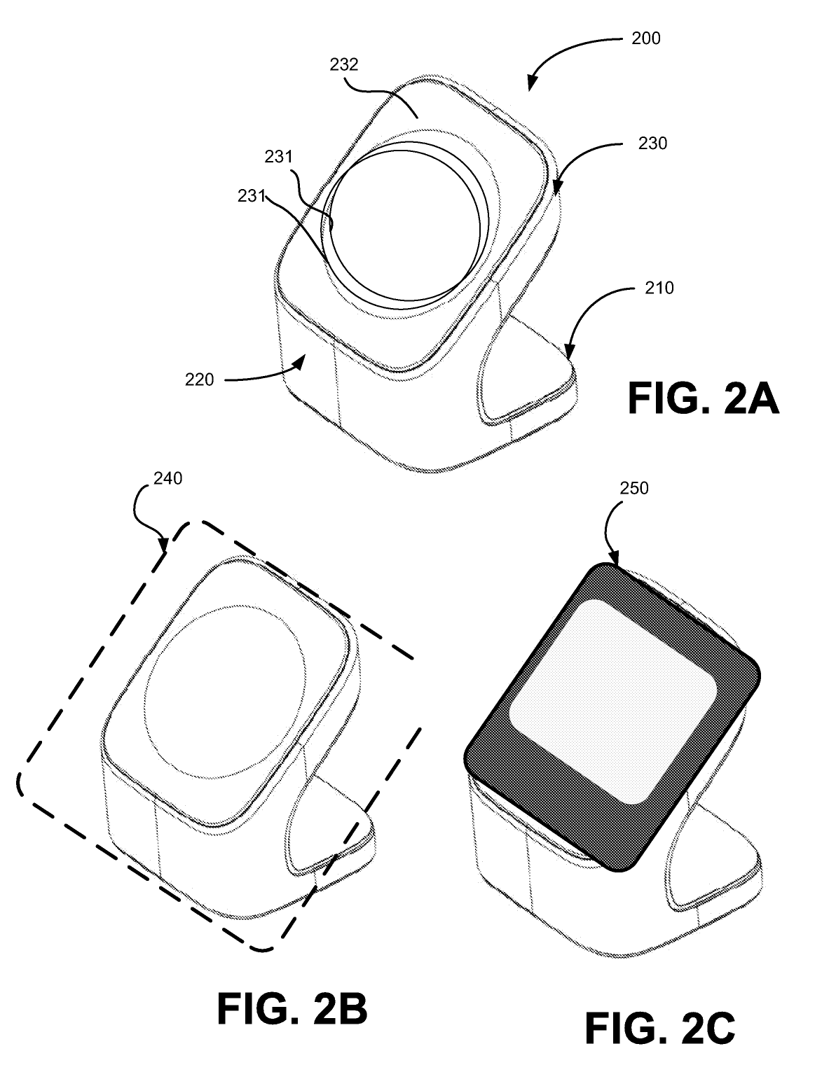

FIG. 2A is an isometric view of a docking station that includes a mufti-device receiving surface, according to one or more embodiments. More specifically, in FIG. 2A, docking station 200 includes a retention platform 230 that has a receiving surface 232 for receiving devices of varying dimensions or shape, as defined by a mating façade of the respective computing device. The retention platform 230 is elevated with respect to the base structure 210. The extension member 220 extends from the base structure 210 to elevate the retention platform 230. In an embodiment depicted, docking station 200 is unitarily formed as a single-piece structure. Accordingly, the docking station includes various contours and shapes to serve design and aesthetic purposes.

According to one or more embodiments, the receiving surface 232 is concave, and includes multiple points of incidents with corresponding gradients in order to receive and accommodate a specific façade of a particular type of computing device. Additionally, one or more embodiments provide that separate points of incidents 231, and corresponding gradients, are formed into the concave shape of the receiving surface 232 in order to accommodate each of multiple types of computing devices in multiple orientations (e.g., both landscape and portrait modes).

In FIG. 2B, the docking station of FIG. 2A is shown to receive a computing device that corresponds to a tablet 240. To accommodate tablet form factor, the receiving surface 232 is shaped include a point of incident, and a contour gradient that matches to the meeting surface (the rear façade) of the tablet. As mentioned, the tablet 240 can also be oriented in either landscape or portrait orientations, or alternatively, in one or more intermediate orientations. For each anticipated orientation that the tablet can occupy on the docking station 200, the receiving surface 232 may include a separate point of incident 231 (see FIG. 2A), and corresponding contour gradients, in order to accommodate the particular geometric requirements of the tablet 240 mating façade (not shown) in the particular orientation. In addition to receiving a tablet form factor device, the docking station of FIG. 2B may also be configured to receive a small-form factor or mobile device, according to an embodiment.

Similarly, in FIG. 2C, docking station 200 is shown to be mated with a mobile computing device 250. The mobile computing device may correspond to any small form factor device, such as a cellular telephony/messaging device, or multifunction wireless device (e.g., smart phone). The receiving surface 232 may include a point of incident and structural gradient to accommodate the mating façade (e.g., rear façade) of the mobile computing device 250. Additionally, one or more embodiments providing the receiving surface 232 (FIG. 2A) includes a point of incident 231 (see FIG. 2A) and structural gradients to accommodate the mating façade multiple orientations, such as landscape and portrait orientations. In this way, a user of the devices such as shown by FIG. 2B and FIG. 2C may orient their computing device on the docking station 200 in a matter of their preference, without losing the functionality provided by the docking station 200.

According to some embodiments, the docking station 200 includes resources that extend, enhance or augment the functionality of the computing device that is mated onto the docking station. In one embodiment, a docking station 200 includes ports for media output. Thus, video (e.g., display or monitor) and/or audio output (e.g., speakers) may be connected to the docking station 200 to provide corresponding outputs that originates from data carried on the computing device that is mated to the docking station 200. As alternative examples, docking station 200 may be physically or wireless connected to a personal computer, or third computer device, which can then share resources and/or connect with the computing device that is mated onto the docking station 200. The docking station 200 may include logic that triggers connectivity between the docking station 200 (or its connected peripherals or resources), and the mated computing device. The triggers may be initiated by the proximity, or presence of the computing device 240, 250 on the receiving surface 232. The automated detection and use of such data using inductive mediums is described in the following patent applications, which are incorporated by reference in their respective entirety: U.S. patent application Ser. No. 12/916,388, filed Oct. 29, 2010; U.S. patent application Ser. No. 12/620,478, filed Nov. 17, 2009; and U.S. patent application Ser. No. 12/478,766, filed Jun. 4, 2009.

With respect embodiments that incorporate an inductive signal interface or NFC interface, the presence of the mated computing device may automatically be detected through coils. Subsequent connectivity between the docking station 200 and the mated computing device 240, 250 may be achieved by way of a wireless link that is automatically established as a result of data being transferred through the inductive (or NFC interface).

With respect to embodiments of FIG. 2A through FIG. 2C, one or more embodiments provide that the devices are inductively and magnetically coupled to the docking station 200. To enable inductive coupling, the computing devices that can be mated to the docking station may be configured to include separate inductive interfaces on surfaces or façades that are accommodated by the shape and dimensions of the receiving surface 232. The computing devices may also include magnetic material that attracts to the magnets (not shown) embedded within or underneath the receiving surface 232. For example, the computing devices may include ferrous material positioned on the façade that is designed to mate with the docking station 200. As an alternative or variation, the docking station 200 may include ferrous material that magnetically couples to magnets of the mating device.

Alternative forms of inductive coupling may be used. For example, the docking station and one or more of the devices may be coupled using standardized NFC interfaces. As an alternatively, physical electrical contacts may be employed.

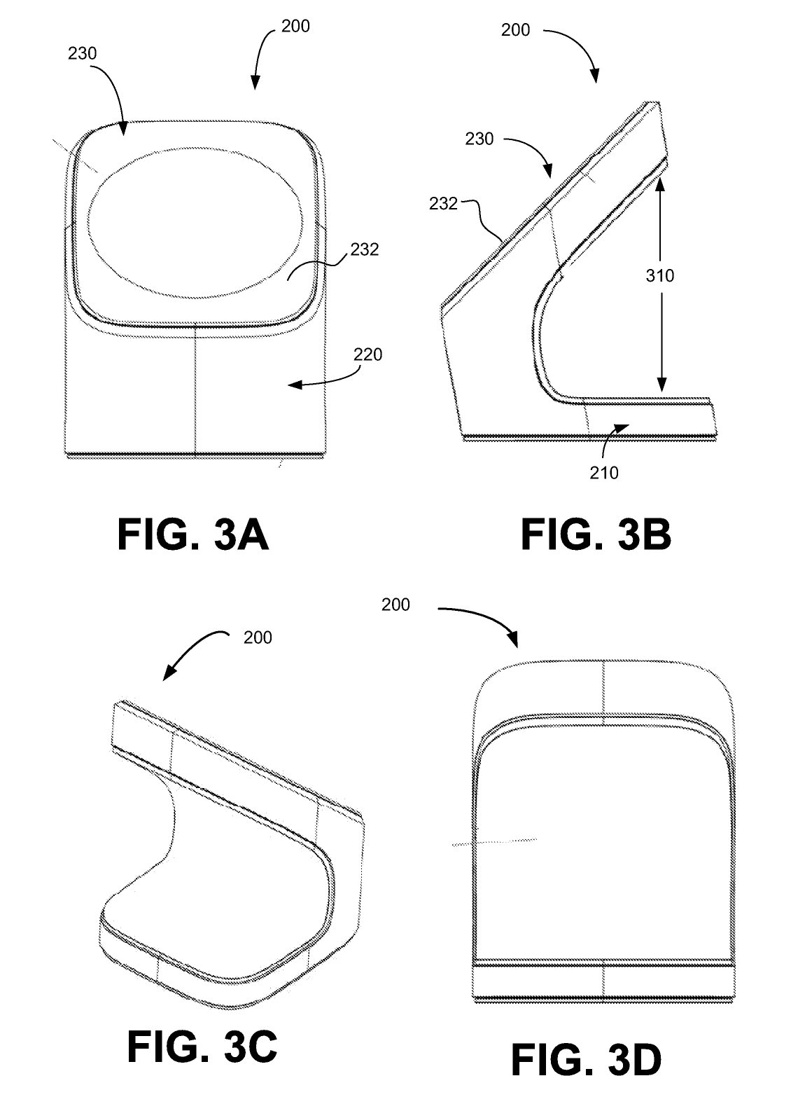

FIG. 3A is a front view of the docking station 200. The extension member 220 extends a width of the docking station 200. The extension member 220 forms a contoured and shaped façade that is unitarily combined with the base structure 210 (see FIG. 3B) and retention platform 230. The receiving surface 232 is acutely angled to receive and retain a computing device.

FIG. 3B is a side view of the docking station of FIG. 3A. FIG. 3C is a rear isometric view of the docking station of FIG. 3A. FIG. 3D is a rear view of the docking station of FIG. 2A. With reference to FIG. 3A through FIG. 3D, the retention platform 230 is structured so that the receiving surface 232 is acutely angled with respect to the horizontal. In some implementations, the receiving surface 232 forms an angle between 30 and 60° with the horizontal. In the particular example depicted, the receiving surface 232 forms an angle of approximately 45° with the horizontal.

The retention platform 230 is elevated over the base structure 210 to form an opening or void 310. Among other benefits, one purpose served by implementations such as shown, which include the void 310, is that the design enables a radio chip/antenna (e.g., Bluetooth component) to be positioned at the retention platform 230, in order to maximize the proximity to the receive computing device when mated. The void 310 eliminates structure that would interfere with the Bluetooth transmissions, which may otherwise occur if the docking station was formed from a solid body. Thus, the void 310 may promote Bluetooth connectivity between the docking station and other peripheral or connected devices, particularly when mated to a computing device received on the retention platform 230.

FIG. 4 illustrates a hardware diagram for a docking station, in accordance with embodiments described herein. Components of docking station 400 may include processor(s) 410, memory 412, the inductive signal interface 420, sensors 430, wireless communication port 440, and physical ports 450. The processor 410, in combination with instructions stored in memory 412, may implement functionality on the docking station for use with mated computing devices. In particular, the processor 410 may utilize credential information received over the inductive signal interface 420 in order to configured one or more bits wireless ports 440. Specifically, the credential information may be used to auto pair the docking station to the mated computing device using, for example, a Bluetooth medium. Additionally, the credential information received over the inductive signal interface 420 may be used to pair the mated computing device to another device that is interconnected or otherwise in communication with the docking station 400. Examples of peripheral or interconnected devices include speakers 460, video output device 464 and/or personal computer 466. Various other devices may alternatively be connected to the docking station 400. The devices 460, 462, 466 may be connected to the docking station using wireless or physical ports 440, 442.

Additionally, components of the docking station 400 include logic and/or hardware for implementing a data bridge between the wireless communication port 440 and one or more physical ports 442. For example, the process of 410 and/or integrated circuit elements may implement a bridge that transforms wireless data received over the wireless communication port 440 (e.g., Bluetooth) into analog signal output that is delivered to, for example, speakers or other output device. In such embodiments, the docking station 400 may also include components such as an digital-analog converter, and a set of RCA plug connectors to interconnect with media equipment such as speakers. Such implementations enable the docking station 400 to form part of a media dock assembly for computing devices.

Similar communication links may be implemented in reverse. For example, the physical ports 442 may include a USB port that is connected to a scanner, which in turn is able to receive data (e.g., scanned image). The processor may transform such data for output over the wireless communication port 440.

According to some embodiments, the docking station 400 has one primary function of providing power to the mated device. In embodiments in which an inductive signal interface 420 is provided, docking station 400 inductively signals power out through the inductive signal interface 420. A power inlet may be used to receive power from, for example, an AC outlet. As a variation, the docking station 400 may also include batteries, such as rechargeable lithium ion batteries, for purpose of powering and/or recharging devices that are made onto it.

In one embodiment, the docking station 400 provides an media dock that is inductively equipped to power the mated computing device, while currently enabling media from the computing device to the output through resources that are connected or otherwise provided with the docking station. A computing device such as a tablet, or a mobile computing device, may be mated with the docking station 400 (e.g., a rear façade of such device is placed onto the receiving surface of the docking station). By way of inductive pairing, credential information is signaled from the computing device to the docking station 400, and from the docking station to the computing device. This credential information is used by both devices to programmatically and automatically establish a wireless link. Seamless to the user, the docking station 400 and mated computing device become wirelessly connected, while the mated computing device is also inductively coupled to receive power from the docking station. The wireless port 440 of the docking station 400 may then receive data from the mated computing device. This data can include media data. The processor 410 (or other processing resources) of the docking station 400 bridges that data to a physical output port, which results in the media data being output on a connected peripheral device (e.g., speakers) of the docking station.

It is contemplated for embodiments described herein to extend to individual elements and concepts described herein, independently of other concepts, ideas or systems, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

What is claimed is:

1. A docking station comprising:
a base structured to rest on an underlying surface; and
a retention platform, including one or more magnets and a receiving surface that is elevated from and supported by the base, the retention platform being capable of retaining multiple types of computing devices at an acute angle above the underlying surface.

2. The docking station of claim 1, wherein the receiving surface of the retention platform is contoured to accommodate a façade of each of the multiple types of computing devices.

3. The docking station of claim 2, wherein the receiving surface of the retention platform is configured to accommodate multiple facades of different contour and size.

4. The docking station of claim 1, wherein the receiving surface is formed from plastic or glass.

5. The docking station of claim 1, further comprising an inductive signal interface provided with the retention platform to supply power to a computing device that is retained on the retention platform.

6. The docking station of claim 5, wherein the receiving surface of the retention platform is formed from glass and overlays the inductive signal interface in receiving another device.

7. The docking station of claim 1, wherein the retention platform is capable of retaining a given computing device in any one of a plurality of orientations, including portrait and landscape orientations.

8. The docking station of claim 1, further comprising a wireless communication port and processing resources to wirelessly link the docking station to a given computing device that is brought into contact to the retention platform

9. The docking station of claim 8, wherein the wireless communication port automatically and wirelessly links the docking station to the given computing device in response to that device being brought into contact with the retention platform.

10. The docking station of claim 1, wherein the receiving surface of the retention structure is angled at an angle that is between 30 and 60 degrees relative to the underlying surface.

11. The docking station of claim 1, wherein the receiving surface of the retention structure is angled at an angle that is about 45 degrees relative to the underlying surface.

12. The docking station of claim 1, wherein the base is provided as a platform, and wherein the retention structure includes a member that extends from the base platform.

13. The docking station of claim 1, wherein the retention structure hangs over and is separated from the base by a void.

14. The docking station of claim 1, further comprising one or more ports for connecting to a media output device.

15. The docking station of claim 1, further comprising a media output device.
